(19) United States
(12) Patent Application Publication
(10) Pub. No.: US 2006/0041455 A1
(43) Pub. Date: Feb. 23, 2006

(54) Systems and methods for providing an enhanced option rider to an insurance policy

(76) Inventor: Robert E. Dehais, Hillsborough, NJ (US)

Correspondence Address: MORGAN LEWIS & BOCKIUS LLP, 1111 PENNSYLVANIA AVENUE NW, WASHINGTON, DC, 20004, US

(21) Appl. No.: 11/204,937

(22) Filed: Aug. 15, 2005

Related U.S. Application Data
(60) Provisional application No. 60/601,368, filed on Aug. 13, 2004.

(51) Int. Cl. G06Q 40/00

(52) U.S. Cl. 705/4

(57) ABSTRACT

In one aspect, the invention comprises a computer system for providing a life insurance policy with an enhanced option rider, comprising: an electronic database operable to store data related to policyholders and policy terms; and an insurance administration computer, in communication with the database, for administering the policy; wherein the enhanced option rider allows each beneficiary of the life insurance policy to apply all or part of eligible proceeds to one or more enhanced payment options, and wherein the one or more enhanced payment options comprise a guaranteed monthly payment through an annuitization process for the life of the one or more beneficiaries.

### CROSS REFERENCE TO RELATED APPLICATIONS

This application claims priority to U.S. provisional patent application No. 60/601,368, filed Aug. 13, 2004. The entire contents of this provisional application are incorporated herein by reference.

### FIELD OF INVENTION

The present invention relates to system and method for providing a life insurance policy, more particularly an insurance rider which enhances the value of the life insurance policy by providing enhanced settlement payout options to the beneficiary(ies) upon the death of the insured.

### BACKGROUND OF THE INVENTION

Currently, an insured has various options in purchasing a life insurance policy, such as term, whole or universal. Additionally, the insured can purchase term life insurance with level premiums over a predetermined period of time, e.g., 20 or 30 years. Generally, upon the death of the insured, these various types of life insurance policies provide lump sum death benefit proceeds or a payout to the beneficiary at rates which are declared by the insurer at the time of payment and which are not less than minimum rates guaranteed in the policy. However, the insured currently has no option of enhancing the payout rate and/or term so that his/her beneficiary can elect to receive enhanced settlement options, e.g., lifetime guaranteed monthly payments, such as through an annuitization process. Currently, the only available mechanism for improving the death settlement payout is to increase the face amount of the policy, which can greatly increase the premium of the life insurance policy. Therefore, it is desirable to provide an enhanced option rider which provides enhanced settlement payments that are guaranteed and at a lower cost than currently available alternatives.

### SUMMARY OF THE INVENTION

It is therefore one object of the present invention to provide a system for enhancing a life insurance policy. The system comprises an enhanced option rider that allows each beneficiary of the life insurance policy to apply all or part of eligible proceeds to one or more enhanced payment options. The one or more enhanced payment options comprise a guaranteed monthly payment through an annuitization process for the life of said one or more beneficiaries.

It is another object of the present invention to provide a system for administering an enhanced option rider for a life insurance policy. The system comprises an insurance administration unit for storing information associated with the enhanced option rider and an annuity administration module for processing the eligible proceeds in accordance with provisions of the enhanced option rider.

It is another object of the present invention to provide a method of administering an enhanced option rider for a life insurance policy. The method comprises the steps of: receiving an application for an enhanced option rider; generating an enhanced option rider; and if the enhanced option rider is exercised, then processing the proceeds of the life insurance policy according to the enhanced option rider; or, if the enhanced option rider has not been exercised, then holding the proceeds in an account until the enhanced option rider is exercised.

In one aspect, the invention comprises a computer system for providing a life insurance policy with an enhanced option rider, comprising: an electronic database operable to store data related to policyholders and policy terms; and an insurance administration computer, in communication with the database, for administering the policy; wherein the enhanced option rider allows each beneficiary of the life insurance policy to apply all or part of eligible proceeds to one or more enhanced payment options, and wherein the one or more enhanced payment options comprise a guaranteed monthly payment through an annuitization process for the life of the one or more beneficiaries.

In various embodiments: (a) the enhanced option rider further comprises a maximum allowable death benefit and the eligible proceeds up to the maximum allowable death benefit are applied to the one or more enhanced payment options; (b) the guaranteed monthly payment is guaranteed for a predetermined period of time; (c) the one or more enhanced payment options comprise an escalation feature such that the guaranteed monthly payment increases during the life of the beneficiary; (d) the enhanced option rider comprises provisions stating that the enhanced option rider cannot be added after the issuance of the life insurance policy and is not available for group conversions or guaranteed issue; (e) the cost of the enhanced option rider may be calculated based on one or more of the following: (i) the death benefit of the life insurance policy on the policy date; (ii) the death benefit of each requested increase in the face amount of the life insurance policy; (iii) the death benefit of any riders on the life of the insured attached to the life insurance policy on the issue date of the policy; and (iv) the death benefit of any rider on the life of the insured attached after the issue date of the life insurance policy; (f) the cost of enhanced option rider does not include any death benefit paid under an accidental death benefit rider or other comparable riders; (g) the enhanced option rider is terminated and the charges cease on the monthly anniversary following the receipt of written request to terminate the rider by the policy owner; or the life insurance policy being continued under a non-forfeiture option; or the face of the life insurance policy decreasing below certain predetermined dollar amount; (h) the enhanced option rider provides each beneficiary with a higher monthly death payment than the life insurance policy without the enhanced option rider; and (i) the system further comprises an annuity administration module for processing the eligible proceeds in accordance with provisions of the enhanced option rider.

In another aspect, the invention comprises a method of administering an enhanced option rider for a life insurance policy, the life insurance policy providing eligible proceeds to one or more beneficiaries upon the death of the policy owner, the enhanced option rider allowing each beneficiary of the life insurance policy to apply all or part of eligible proceeds to one or more enhanced payment options, the one or more enhanced payment options comprising a guaranteed monthly payment through an annuitization process for the life of the beneficiary, the method comprising the steps of: (a) receiving an application for an enhanced option rider; (b) generating an enhanced option rider; and (c) if the enhanced option rider is exercised, then processing the proceeds of the life insurance policy according to the enhanced option rider; or, if the enhanced option rider has not been exercised, then holding the proceeds in an account until the enhanced option rider is exercised.

### BRIEF DESCRIPTION OF DRAWINGS

FIG. 1 shows a method of administering the Enhanced Option rider according to one embodiment of the present invention.

FIG. 2 shows a system for administering the Enhanced Option rider according to one embodiment of the invention.

### DETAILED DESCRIPTION OF EMBODIMENTS

One embodiment of the present invention comprises an enhanced payment option rider that allows each beneficiary of the life insurance policy (“Policy”), not an assignee, to apply all or part of the eligible proceeds received upon the insured's death to one or more enhanced payment options (“Enhanced Option”), as described herein. The Enhanced Option rider, such as the Guaranteed Survivor Income Benefit (GSIB) or Enhanced Life Income Options, is subject to all applicable terms and provisions of Policy, except as modified by the enhanced payment option rider.

In one embodiment, the Enhanced Option rider provides the beneficiary with an option of exchanging all or part of the lump sum death benefit proceeds of a life policy for enhanced lifetime guaranteed monthly payments through an annuitization process. The Enhanced Option rider premium is paid by the policy owner or the insured, but provides enhanced payment options to the beneficiary that are exercisable upon the death of the insured. For example, the enhanced payment options include but are not limited to guaranteed monthly payments, hedge against rising interest rates, annuity payout at a higher rate, and higher monthly death payments at a lower cost. Preferably, the Enhanced Option rider is exercisable only at the time of death of the insured and not at a partial or full surrender.

The Enhanced Option rider may provide each beneficiary with a higher monthly death payment than the standard life insurance policy without the Enhanced Option rider. To obtain the higher monthly death payment without this rider, the insured could increase the face amount of the policy. However, such an increase would significantly increase the premium of the policy because the premium is directly related to the amount of the death benefit. For example, if the total premium on the life insurance policy with the Enhanced Option rider increases by 3-4%, the life insurance policy (without the Enhanced Option rider) premium will increase by 40% to achieve the same level of monthly death payment as the life insurance policy having a lower face amount and the Enhanced Option rider of the present invention. The Enhanced Option rider enables the policy owner and insured to provide his/her beneficiary with enhanced death payment at the fraction of the cost.

Additionally, an Enhanced Option rider provider, such as the issuer of the Policy, may establish various terms and conditions for offering the Enhanced Option rider. These terms and conditions may include, for example, provisions stating that the Enhanced Option rider cannot be added after the issuance of the Policy and is not available for group conversions or guaranteed issue. The issuer may also restrict the availability of the Enhanced Option rider, e.g., it may not be available if the base coverage of the Policy was issued in certain substandard underwriting classes, for example if it has a Table rating greater than F (150%) or a flat extra. Additionally, it can be made available only on policies with face amounts of $100,000 and above. Further, the Enhanced Option rider may have a maximum allowable death benefit to which it can be applied, which may be less than or the same as the death benefit of the underlying Policy. That is, the Enhanced Option rider may apply to the full or a portion of the Policy's death benefit, e.g., the first $2 million of death benefit. Policies with death benefits exceeding the maximum allowable death benefit of the Enhanced Option rider may be still issued with the Enhanced Option rider, but both the benefit and premium charges for the rider will be based on the maximum allowable death benefit, e.g., $2 million.

As used herein, Eligible Proceeds are equal to the portion of the life insurance policy proceeds payable to a beneficiary at the death of the insured under the Policy to which the Enhanced Option rider is attached, less the portion of any proceeds payable under any accidental death benefit rider or other comparable riders attached to the Policy.

In accordance with one embodiment of the present invention, the cost of the Enhanced Option rider may be calculated from the Eligible Death Benefits. The amount available for option exercise may be the Eligible Death Benefits, net of indebtedness (any existing loans, collateral assignments, uncollected charges, etc.) at the time of death of the insured. The Eligible Death Benefits may include one or more of the following:

1. The death benefit of the Policy on the Policy Date, including the death benefit of any automatic increases in the face amount of the Policy under a death benefit option and including any death benefit provided by policy dividends.

2. The death benefit of each requested increase in the face amount of the Policy.

3. The death benefit of any riders on the life of the insured attached to the Policy on the issue date of the Policy.

4. The death benefit of any rider on the life of the insured attached after the issue date of the Policy.

However, preferably, Eligible Death Benefits do not include any death benefit paid under an accidental death benefit rider or other comparable riders. In accordance with an aspect of the present invention, the Enhanced Option charge or premium for the base policy's death benefit may be based on each segment's Discounted Face Amount, rather than each segment's death benefit (with the maximum allowable death benefit cap applied before the discounting). For example, the Discounted Face Amount may be used in processing universal life secondary guarantee (ULSG) policies to simplify the calculations since ULSG currently has only a fixed death benefit and no option for an increasing death benefit. However, this exception may be temporary for ULSG policies and the segmented Death Benefit may have to be used in the future. This simplification, which may produce a charge/premium that is less than or equal to the charge/premium produced without the simplification, may not be reflected in the Enhanced Option rider contract.

The monthly charge or cost of the Enhanced Option rider may be charged as a part of the monthly deduction on the Policy. In accordance with one embodiment of the present invention, the monthly cost may be based on the per thousand dollars of Eligible Death Benefits in force, up to the maximum allowable death benefit of the selected Enhanced Option rider. These charges associated with the Enhanced Option rider may be payable for the life of the Policy, as long as the Enhanced Option rider is in force. In accordance with an aspect of the present invention, the appropriate monthly rates per thousand of Eligible Death Benefit may be multiplied by the Eligible Death Benefit divided by 1,000 (by segment), and the resulting Enhanced Option rider charges, such as the monthly cost of rider rate shown on the specification page of the Policy, by segment can each be rounded to 2 decimal places. Preferably, the monthly charges may vary by band and sex, issue age, rating class, and smoking class of the insured. For example, target premiums and monthly charges may vary by base policy band, as follows: $100,000-$249,999; $250,000-$999,999; and $1,000,000-$2,000,000.

In accordance with another embodiment of the present invention, all or part of each beneficiary's Eligible Proceeds may be applied to one or more Enhanced Options, subject to the following:

1. Total proceeds applied to the Enhanced Options upon the death of the insured of the Policy may not exceed the maximum allowable death benefit of the Enhanced Option rider. If there is more than one beneficiary under the Policy and the proceeds of the Policy are greater than the maximum allowable death benefit, each beneficiary may only apply a pro-rata portion of his/her share to one or more Enhanced Option. The pro-rata share may be based on the same ratios under which the proceeds of the Policy were payable.

2. The Enhanced Option rider may only be available if the monthly Enhanced Option payments (or benefits payment or installments) are at least some predetermined monthly minimum payout amount, e.g., $50.

3. The beneficiary must provide a written notice of his/her election to receive the Enhanced Option (or a particular Enhanced Option if more than one is offered) within a certain period, such as 60 days, after the notification of the availability of the Enhanced Option is sent by the issuer to the beneficiary and/or within a predetermined period, such as 9 months from the date of death of the insured.

4. Once payments begin under the Enhanced Option rider, future payments may not be assigned and the beneficiary cannot change the selected Enhanced Option.

5. In accordance with an embodiment of the present invention, if the beneficiary is a trust with one natural person as beneficiary, the beneficiary may select an Enhanced Option from all available Enhanced Options. Otherwise, if the trust has no beneficiary as a natural person or if the beneficiary is a corporation or other non-natural person, the beneficiary may have a limited selection and may be limited for example to the 10 Year Certain option.

In accordance with yet another embodiment of the present invention, if there is more than one beneficiary in the Policy, the Enhanced Option may be selected by one or more beneficiaries. That is, the Enhanced Option may not need to be selected by all of the beneficiaries of the Policy. The Enhanced Option is available to all the beneficiaries, but may not require election by all of the beneficiaries. In accordance with an aspect of the present invention, the beneficiaries named by the Policy owner may choose whether or not to exercise the Enhanced Option at the insured's death. Each of the multiple primary beneficiaries may independently elect one of the Enhanced Options available under the Enhanced Option rider.

In accordance with yet another embodiment of the present invention, a beneficiary may choose to select more than one Enhanced Option (i.e., more than one Enhanced Option payment method) by designating the percentage of the proceeds for each Enhanced Option, totaling not more than 100%, and providing that the resulting payout for each selected Enhanced Option produces at least the predetermined monthly minimum payout amounts, e.g., $50. The various Enhanced Option payments can provide sex distinct benefits on sex distinct base policies and unisex benefits where required to comply with local laws and/or regulations.

When an Enhanced Option starts, the issuer or its affiliate generally issues a contract describing the terms and conditions of the Enhanced Option which will be delivered to the beneficiary(ies). Each beneficiary shall receive a notification of his/her rights under the selected Enhanced Option rider from the issuer or its designated agent at the time the Policy proceeds become payable.

The monthly Enhanced Option payments after the death of a beneficiary (if provided under the option selected) will be paid as due to that beneficiary's successor beneficiary. If there is no successor beneficiary, total remaining payments will be paid in one lump sum to the estate of the last beneficiary to die. If a beneficiary dies within a predetermined period, such as 30 days, after the Option Date (the effective date of the Enhanced Option), in accordance with an embodiment of the present invention, the amount of the proceeds to be distributed under the selected Enhanced Option, less any payments made, will be paid in one lump sum.

In accordance with yet another embodiment of the present invention, the benefits or payments under the selected Enhanced Option, such as the Enhanced Life Income Options, are based on the age and sex of the beneficiary on the Option Date. Benefits for this rider are paid based upon the age and sex (where unisex benefits are not required) of the beneficiary (and choice of payout option) at the death of the insured. For example, the current annuity rules and provisions for determining the age of the beneficiary may be followed when an enhanced payout option is elected. The Enhanced Option or Life Income payments may be the maximum of the Enhanced Option payment rates specified in the Enhanced Option rider for the selected Enhanced Option, e.g., 10 Year Certain, 15 Year Certain, etc., based on beneficiary's age and sex or the Enhanced Option payments may be based on certain percentage, such as 105%, of the current or predetermined Payment Option rates of the issue on the Option Date. Preferably, if the rates at a given age are the same for different periods certain, the longest period certain will be deemed to have been chosen.

In accordance with yet another embodiment of the present invention, the Enhanced Option may provide equal monthly payments that include both principal and interest. For example, the Enhanced Option payments start on the Option Date and will continue for 10 years. In accordance with one aspect of the present invention, the Enhanced Option monthly payment or the guaranteed monthly payment per $1,000 of proceeds of the Policy may not be less than the monthly payment specified in the Enhanced Option rider based on the age and sex of the beneficiary or 105% of the 10 Year Certain Payment Option rates on the Option Date.

In accordance with yet another embodiment of the present invention, the Enhanced Option rider may comprise, but not be limited to, one or more following Enhanced Options: 10-year certain; Life only; 10-year, 15-year, 20-year certain and life; Life only with 1%, 2%, or 3% escalation feature; and 10-year certain and life with a 1%, 2%, or 3% escalation feature.

In accordance with yet another embodiment of the present invention, the Enhanced Option rider may provide Enhanced Life Income wherein the monthly Enhanced Option payments start on the Option Date and continue:
1. During the life of the beneficiary, with no payment after the death of the beneficiary, called “Enhanced Life Income, No Refund”; or
2. During the life of the beneficiary, but for at least 10 years, called “Enhanced Life Income, 10 Years Certain”; or
3. During the life of the beneficiary, but for at least 15 years, called “Enhanced Life Income, 15 Years Certain”; or
4. During the life of the beneficiary, but for at least 20 years, called “Enhanced Life Income, 20 Years Certain.”

In accordance with yet another embodiment of the present invention, the Enhanced Option rider may provide an Enhanced Increasing Life Income wherein the monthly Enhanced Option payments start on the Option Date and increase over time during the life of the beneficiary (i.e., an escalation feature), with no payment after the death of the beneficiary. For example, the monthly Enhanced Option payments can increase at:
1.1% per year called “1% Enhanced Increasing Life Income”; or
2.2% per year called “2% Enhanced Increasing Life Income”; or
3.3% per year called “3% Enhanced Increasing Life Income.”

In accordance with yet another embodiment of the present invention, the Enhanced Option rider may provide Enhanced Increasing Life Income—10 Year Certain wherein the monthly Enhanced Option payments start on the Option Date and increase over time during the life of the beneficiary (i.e., an escalation feature). The monthly Enhanced Option payments are guaranteed for at least 10 years. For example, the monthly Enhanced Option payments can increase at:
1. 1% per year, called “1% Enhanced Increasing Life Income, 10 Year Certain”; or
2. 2% per year, called “2% Enhanced Increasing Life Income, 10 Year Certain”; or
3. 3% per year, called “3% Enhanced Increasing Life Income, 10 Year Certain.”

Other Enhanced Payment Options and payment frequencies are contemplated and are within the scope of this invention.

The Enhanced Option rider may be terminated and the charges cease on the monthly anniversary following: the receipt of a written request to terminate the rider by the policy owner; the Policy being continued under a non-forfeiture option; or the face of the Policy decreasing below a certain predetermined dollar amount, e.g., $25,000.

In accordance with one embodiment of the present invention, if a policy face amount is subsequently increased, the Enhanced Option premium charged for the new segment may be based upon the age and rating class of the beneficiary at the time of the increase. In the determination of death benefit and band by segment, preferably, the Enhanced Option rider may follow the rules of the base policy. If the death benefit for a policy with more than one segment exceeds the maximum allowable death benefit, e.g., a cap of $2,000,000, the death benefit up to the maximum allowable death benefit cap may be allocated first to the original segment, and then to each subsequent segment until the maximum allowable death benefit cap is reached.

If a policy face decreases below the predetermined threshold minimum amount, e.g., $100,000, the Enhanced Option rider may continue in force, applying the rates for the $100,000 band. If, however, the policy face decreases below the predetermined minimum amount, e.g., $25,000, the Enhanced Option rider may terminate.

Preferably, when there is a partial surrender of face amount, the premium reduction may be processed in the same manner as for the base policy (e.g., LIFO, by segment). The Enhanced Option rider premium and benefits may not vary by death benefit option. In accordance with one aspect of the present invention, when a death benefit option changes, the premium charged per thousand of death benefit may follow the rules of the base policy (e.g., if the base policy takes a change in band into account, so will the Enhanced Option rider).

If the Policy with the Enhanced Option rider as of the time of lapse or time of moving to a non-forfeiture option is subsequently reinstated (or returned to premium-paying status), the issuer may reinstate the Enhanced Option rider along with the Policy. However, if the Enhanced Option rider is terminated separately from the base policy (other than due to the policy moving to non-forfeiture status), the issuer may not be obligated to reinstate the Enhanced Option rider.

The benefit provided under the Enhanced Option rider is generally not considered a Qualified Additional Benefit for tax purposes. Additionally, the Enhanced Option rider is not generally considered an additional benefit in the calculation of guideline premium limits or seven-pay TAMRA Technical and Miscellaneous Revenue Act (TAMRA) premium limits, and any premium for the Enhanced Option rider will be added to other premium payments and tested against such limits. TAMRA is a 1988 federal law that created a new class of life insurance contracts, Modified Endowment Contracts. Unlike other life insurance policies, these contracts' policy loans and surrender payments are subject to taxation rules similar to deferred annuities.

In accordance with an embodiment of the present invention, the Enhanced Option rider can be commissionable (i.e., it will increase the Commissionable Target Premium, No-Lapse Guarantee premium, and the Minimum Premium to Issue). The Enhanced Option rider of the present invention follows the current practice for commissions on settlement options with regard to commissions paid upon annuitization.

In accordance with an embodiment of the present invention, if the Enhanced Option rider is attached to a convertible term policy that is converted to a permanent policy, the Enhanced Option rider will be issued on the new permanent policy without underwriting, assuming the Enhanced Option rider is available on the new policy for the age and amount being issued.

In accordance with an embodiment of the present invention, once an enhanced payout option is elected, the payment stream may not be assigned to any other individual or entity. Payments will end upon the death of the beneficiary unless a period certain option is chosen. In that case the current payment will continue, without change, to the named recipient for the balance of the stated period.

Appendices A and B are two exemplary Enhanced Option riders generated according to one or more embodiments of the present invention.

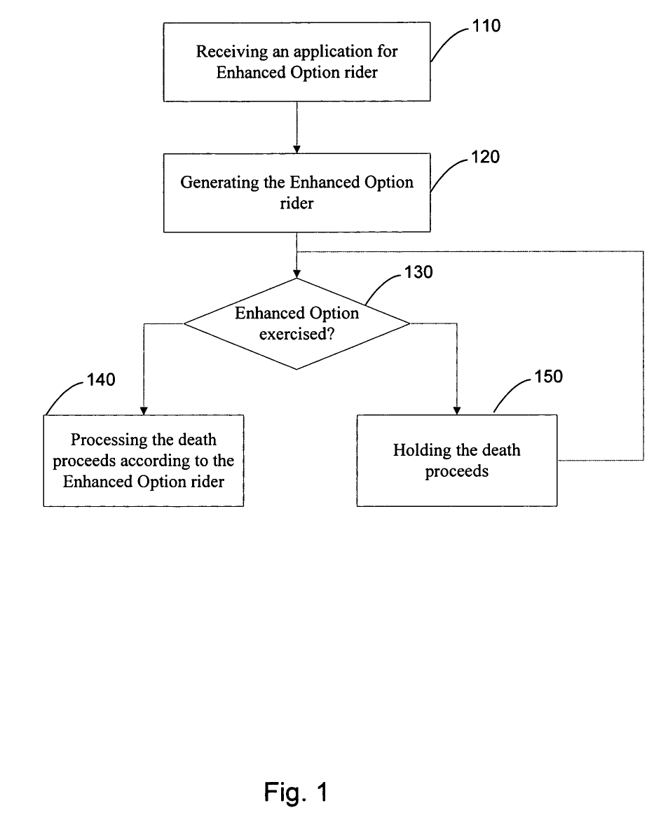

FIG. 1 is a flow chart showing a method of administering the Enhanced Option rider according to one embodiment of the present invention. In this embodiment, an application for Enhanced Option is from a beneficiary at step 110. At step 120 the system processes the application and generates the terms and conditions of the Enhanced Option rider. In generating the Enhanced Option rider, computer means may be used to calculate the Eligible Proceeds, the Eligible Death benefits, the cost of the rider and the Enhanced monthly payment of the rider. At step 130 the system tests whether the Enhanced Option rider is exercised by the beneficiary. If the Enhanced Option rider is exercised, at step 140 the system processes the death proceeds according to the terms and conditions of the rider. If the Enhanced Option rider has not been exercised, at step 150 the system places the death proceeds into a total control account or some other comparable interest bearing account, typically while the beneficiary is deciding whether to elect the Enhanced Option rider of the present invention.

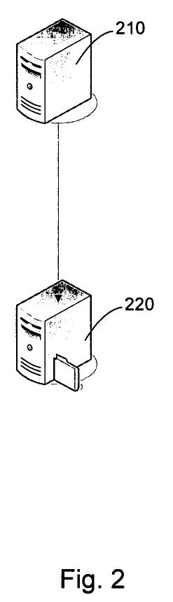

FIG. 2 shows a system for administrating the Enhanced Option rider according to one embodiment of the invention. The system comprises an insurance administration unit 210 that comprises one or more computers and databases storing information associated with the Enhanced Option rider, e.g., beneficiary, the selected Enhanced Option, etc., and funds (i.e., death proceeds). When the Enhanced Option rider is exercised, the insurance administration unit 210 transfers the information data to an Annuity Administration module 220. The Annuity Administration module 220 comprises one or more computers for processing the death proceeds in accordance with the Enhanced Benefit Option(s) selection made by the beneficiary. If the Enhanced Option rider is not exercised, the Annuity Administration module 220 places the death proceeds into a total control account or some other comparable interest bearing account, typically while the beneficiary is deciding whether to elect the Enhanced Option rider of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein map be utilized according to the present invention. Accordingly, the appended claims are intended to include within their scope such processes, machines, manufacture, compositions of matter, means, methods, or steps.

Embodiments of the present invention comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, may be transmitted electronically over a computer network. Further, all data preferably is stored in one or more electronic databases.

### APPENDIX A

### Enhanced Payment Option Rider

This Rider allows each Beneficiary of this Policy, who is not an assignee, to apply all or part of the Eligible Proceeds received upon the Insured's death to one or more Enhanced Payment Option (called “Enhanced Option”) as described and limited below. This Rider is subject to all applicable terms and provisions of the Policy, except as modified herein. This Rider is a part of the Policy if it is listed on the Policy Specifications page.
Eligible Proceeds. Eligible Proceeds equal: the portion of the policy proceeds payable to a Beneficiary at the death of the Insured under the Policy to which this rider is attached; less the portion of any proceeds payable under any Accidental Death Benefit Rider. The Eligible Proceeds that can be applied to an Enhanced Option are subject to the Conditions below.
Eligible Death Benefits. Eligible Death Benefits are used to calculate the cost of this Rider. Each of the following will be an Eligible Death Benefit:
1. The Death Benefit of the Policy on the Policy Date; plus the Death Benefit of any automatic increases in Face Amount under a Death Benefit Option.
2. The Death Benefit of each requested increase in Face Amount.
3. The Death Benefit of any riders on the life of the Insured attached to this Policy on the Issue Date of the Policy.
4. The Death Benefit of any rider on the life of the Insured attached after the Issue Date of the Policy
However, any Death Benefit paid under an Accidental Death Benefit rider will not be an Eligible Death Benefit.
Option Date. The Option Date is the effective date of the Enhanced Option as chosen.

Monthly Cost of Rider The Monthly Cost of Rider for the following month is charged as part of the Monthly Deduction. The Monthly Cost of Rider is the total of: each Eligible Death Benefit as described above; divided by $1,000; times the Monthly Cost of Rider Rate shown on the Policy Specifications page for that Eligible Death Benefit.
The Monthly Cost of Rider will be determined based on each Eligible Death Benefit in the order in which they became effective, up to $2,000,000 of Eligible Death Benefit. We reserve the right to charge a lower Monthly Cost of Rider.

Conditions All or part of each Beneficiary's Eligible Proceeds can be applied to one or more Enhanced Option, subject to the following:
1. Total proceeds applied to the Enhanced Options upon the death of the Insured of the Policy cannot exceed $2,000,000. If there is more than one Beneficiary under the Policy and the policy proceeds of the Policy are greater than $2,000,000, each Beneficiary can only apply a pro-rated portion of his/her share to one or more Enhanced Option. The pro-rated share will be based on the same ratios under which the proceeds of the Policy were payable.
2. If monthly instalments under an Enhanced Option would be less than $50, proceeds car be applied to the Enhanced Option only with our consent.
3. We must receive the choice of an Enhanced Option from the Beneficiary in written form satisfactory to us at our Designated Office within the later of: 60 days from the date we send the Beneficiary the Notification described in this Rider; and 9 months from the date of death of the insured.
4. Once payments begin under this Rider, future payments cannot be assigned and the Enhanced Options chosen cannot be changed.
5. If the Beneficiary is a trust with one natural person as Beneficiary, all Enhanced Options are available to be chosen. Otherwise, if the Beneficiary is not a natural person, the choice of an Enhanced Option will be limited to the 10 Year Certain option.
When an Enhanced Option starts, a contract will be issued by us or an affiliate designated by us that will describe the terms of the Option.

Death of Beneficiary Amounts to be paid after the death of a Beneficiary under an Enhanced Option will be paid as due to that Beneficiary's successor Beneficiary. If there is no successor Beneficiary, amounts will be paid in one sum to the estate of the last Beneficiary to die. If a Beneficiary dies within 30 days after the Option Date, the amount applied to the Enhanced Option, less any payments made, will be paid in one sum.

Notification We will send each Beneficiary a Notification of his/her rights under this Rider at the time the policy proceeds become payable.

Enhanced Life Income Enhanced Life Income Options are based on the age and sex of the Options Beneficiary on the Option Date. We will require proof of age. The Enhanced Life Income payments will be based on; the rates shown in the Tables below; or, if greater, 105% of our Payment Option rates on the Option Date. If the rates at a given age are the same for different periods certain, the longest period certain will be deemed to have been chosen.

Enhanced 10 Years Equal monthly payments will be made that will include both Certain OPEN: WHAT principal and interest. Payments will start on the Option Date and IS THE MAXIMUM will continue for 10 years. The guaranteed monthly payment per AMOUNT TO BE USED $1,000 of proceeds will not be less than $X.XX; or 105% of the 10 HERE? Year Certain Payment Option rates on the Option Date

Enhanced Life Income Equal monthly payments will start on the Option Date and will continue:
1. During the life of the Beneficiary, with no payment after the death of the Beneficiary, called “Enhanced Life Income, No Refund”; or
2. During the life of the Beneficiary, but for at least 10 years, called “Enhanced Life Income, 10 Years Certain”; or
3. During the life of the Beneficiary, but for at least 15 years, called “Enhanced Life Income, 15 Years Certain”; or
4. During the life of the Beneficiary, but for at least 20 years, called “Enhanced Life Income, 20 Years Certain.”

Enhanced Increasing Life Increasing monthly payments will start on the Option Date and will Income continue during the life of the Beneficiary, with no payment after the death of the Beneficiary. Payments will increase at:
1. 1% per year called “1% Enhanced Increasing Life Income”; or
2. 2% per year called “2% Enhanced Increasing Life Income”; or
3. 3% per year called “3% Enhanced Increasing Life Income.”

Enhanced Increasing Life Increasing monthly payments will start on the Option Date and will Income—10 Year continue during the life of the Beneficiary, but for at least 10 years. Certain Payments will increase at:
1. 1% per year called “1% Enhanced Increasing Life Income, 10 Year Certain”; or
2. 2% per year called “2% Enhanced Increasing Life Income, 10 Year Certain”, or
3. 3% per year called “3% Enhanced Increasing Life Income, 10 Year Certain.”

Other Frequencies and Other Enhanced Payment Options and payment frequencies may be Enhanced Options available upon request. We reserve the right to substitute comparable Enhanced Payment Options for those shown below.

Minimum Payments Guaranteed monthly payments for each $1,000 applied will not be under Enhanced less than the amounts shown in the following Tables. On request, Payment Options we will provide additional information about amounts of minimum payments.

Enhanced Life Income OPEN: WHAT NUMBERS SHOULD
BE USED HERE AND IN THE FOLLOWING SECTIONS?

| Payees' | | 10 Year | 15 Year | 20 Year |
|---|---|---|---|---|
| Age | No Refund | Certain | Certain | Certain |
| 50 | | | | |
| 55 | | | | |
| 60 | | | | |
| 65 | | | | |
| 70 | | | | |
| 75 | | | | |
| 80 | | | | |
| 85 | | | | |
| 90 & over | | | | |

Enhanced Increasing Life Income

| Payee's Age | 1% | 2% | 3% |
|---|---|---|---|
| 50 | | | |
| 55 | | | |
| 60 | | | |
| 65 | | | |
| 70 | | | |
| 75 | | | |
| 80 | | | |
| 85 | | | |
| 90 & over | | | |

Enhanced Increasing Life Income - 10-Years Certain

| Payee's Age | 1% | 2% | 3% |
|---|---|---|---|
| 50 | | | |
| 55 | | | |
| 60 | | | |
| 65 | | | |
| 70 | | | |
| 75 | | | |
| 80 | | | |
| 85 | | | |
| 90 & over | | | |

Termination This Rider will terminate upon the first of the following events to occur:
1. The monthly anniversary on or following receipt by us at our Designated Office of your written request to terminate this Rider;
2. The date the Policy terminates for reasons other than the death of the Insured; and
3. The date the Face Amount of the Policy is decreased to less than $25,000.

The Issue Date and effective date of this Rider and the Policy are trio same unless another Issue Date is shown below.

Issue Date:

### Insurance Company

### APPENDIX B

### Record of Decision MLI USA/First MLI/MetLife Affiliated and Independent Distribution Portfolio

The Guaranteed Survivor Income Benefit (GSIB) is a rider available on life insurance policies and is designed to provide enhanced settlement payout options to the beneficiary(ies) upon the death of the insured. This rider will be available on policies introduced on or after Sep. 13, 2004 beginning with the ULSG (04) contract and will be available on MetLife, MetLife Investors USA (MLI-USA) and First MetLife Investors (FMLI) paper.

Rider Features:

This rider is designed so that the beneficiary will have the option of exchanging the lump sum death benefit proceeds of a life policy for enhanced lifetime guaranteed monthly payments through an annuitization process. Partial annuitization of the death benefit is available at the time of death of the insured. The rider is exercisable only at the time of death of the insured and NOT at a partial or full surrender.

Availability:

GSIB is available for insureds ages 20-80. GSIB is not available if the base coverage has a Table rating greater than F (150%) or a flat extra. It cannot be added after issue, and is not available for group conversions or guaranteed issue. It is available on policies of $100,000 and above, but applies only to the first $2 million of death benefit (see the sections on Maximum Benefit and Eligible Death Benefit for more details).

Rider Charges and Target Premiums:

There is a monthly charge for this rider per thousand dollars of Eligible Death Benefit in force, up to the maximum allowable death benefit. See the section on Eligible Death Benefit for more details. These rider charges are payable for the life of the policy, as long as the rider is in force. Monthly charges vary by band and insured sex, issue age, rating class, and smoking class.

The appropriate monthly rates per thousand of Eligible Death Benefit are multiplied by the Eligible Death Benefit divided by 1,000 (by segment), and the resulting rider charges by segment will each be rounded to 2 decimal places.

Banding:

Target premiums and charges vary by base policy band, as follows:

$100,000-5249,999, $250,000-$999,999, and $1,000,000-$2,000,000. (For ease of administration, separate tables containing the same rates will be provided for the $250,000-$499,999, and $500,000-$999,999 bands of ULSG (04).)

Underwriting:

Sex and risk class follow those of the base policy to which the rider is attached.

Termination:

The rider can be terminated. The charges will cease on the monthly anniversary following:
the receipt of written request by the policyowner at the Home Office.
a policy being continued under a nonforfeiture option
a policy s face decreasing below $25,000
   Reinstatement:

If a policy with this rider as of the time of lapse or time of moving to a nonforfeiture option is subsequently reinstated (or returned to premium-paying status), the rider may be reinstated along with the policy.

If, however, the rider is terminated separately from the base policy (other than due to the policy moving to nonforfeiture status), the rider may not be reinstated.

Beneficiary:

The beneficiary(ies) named by the policy owner choose(s) whether or not to exercise the GSIB at the insured's death. Multiple primary beneficiaries are allowed and each can elect an enhanced settlement option available under the GSIB independently.

The beneficiary(ies) will have the later of: 9 months from the date of death or 60 days following the date that the notification is sent to the beneficiary(ies), to exercise the GSIB; otherwise it is lost.

If the beneficiary is changed to a corporation, a partnership, a fiduciary, or any other legal entity the rider and rider charges will continue but the ONLY payment option to be available will be the 10-Year Certain Option. If a trust is the beneficiary with a single specified “natural,” living person stated as the beneficiary of the trust at the time of death of the insured, then all options will be available to the trust.

Beneficiary Age:

Benefits for this rider are paid based upon the age and sex of the beneficiary (and choice of payout option) at the death of the insured. All current annuity rules and provisions for determining the age of the beneficiary will be followed when an enhanced payout option is elected.

There are no age restrictions on beneficiary. The upper limit of the payment rates shown in the rider contract will be age 95.

Maximum Benefit:

The maximum death benefit that can be subject to GSIB enhanced settlement options is $2,000,000. Policies with death benefits exceeding this amount may still be issued with this rider, but both the benefit and premium charged will be based on a maximum of $2,000,000 of death benefit. The minimum policy size (SFA) to which GSIB may be added is $100,000.

Nonforfeiture & Loans:

This rider does not have any cash or other nonforfeiture value and it does not provide for any loan value.

Taxation:

This benefit is not considered a Qualified Additional Benefit for tax purposes. This rider is NOT considered in the calculation of guideline premium limits or seven-pay TAMRA premium limits, and any premium for the rider will be added to other premium payments and tested against such limits.

Compensation:

The rider will be commissionable (i.e. it will increase the Commissionable Target Premium, No-Lapse Guarantee premium, and the Minimum Premium to Issue on ULSG (04) policies), This rider will follow current practice for commissions on settlement options with regard to commissions paid upon annuitization.

Beneficiary Notification:

We will send the beneficiary notification of the benefit at the time the policy proceeds become available; and include the amounts of the payment options in, the letter. The notification will also contain instructions on how to elect benefit payments under the GSIB and the time limit within which an election must be made.

Payment Rates:

The Payment Rates will be the maximum of:
1) Enhanced guaranteed life settlement option payment rates specified it the rider
2) 105% of the current life settlement option payouts at the time of option exercise

The payment rates for Part 1) of the payment calculation above will be provided in table format which will vary based on sex, age, and payment option.

Payment Options:

The following settlement options will be available through the GSIB:
1) 10-year certain
2) Life only
3) 10-year, 15-year, 20-year certain and life
4) Life only with 1%, 2%, or 3% escalation feature
5) 10-year certain and life with 1%, 2%, or 3% escalation feature;
   Payments are Monthly.

Other Enhanced Payment Options and payment frequencies may be available upon request. We reserve the right to substitute comparable Enhanced Payment Options for those listed above.

An option is only available if it produces a monthly benefit payment of at least $50.

A beneficiary may choose to have more than one payment option by designating the percentage of the proceeds for each option, totaling not more than 100%, and providing that the resulting payout for each option selected produces at least $50 of monthly income.

Payment options will be sex distinct on sex distinct base policies and unisex where required. This benefit is not available on Group Conversion or Guaranteed Issue versions.

Eligible Death Benefit:

The amount of eligible death benefit for purposes of this rider includes the base policy and any lump sum death benefits on the life of the insured payable upon the death of the insured under attached riders, other than the Accidental Death Benefit rider.

Note: For ULSG only, the rider charge for the base policy's death benefit will be based on each segment's Discounted Face Amount, rather than each segments death benefit (with the $2,000,000 cap applied before the discounting). This simplification is due to the fact that for ULSG, as there is no Option B and the policy is not likely to enter the 7702 corridor, the result will most likely be the same. Therefore, to avoid unnecessary complexity in the calculations, the Discounted Face Amount will be used in the processing. This is an exception, which may be temporary, and other products will use the segmented Death Benefit. This simplification, which will produce a charge that is less than or equal to the charge produced without the simplification, will not be reflected in the contract.

The amount available for option exercise is the Eligible Death Benefit, net of indebtedness any existing loans, collateral assignments, uncollected charges, etc.) at the time of death of the insured.

Changes in Base Policy Face Amount and Death Benefit Option Changes:

If a policy face amount is subsequently increased, the GSIB premium charged for the new segment will be based upon the age and rating class at increase. In the determination of death benefit and band by segment, the rider will follow the rules of the base policy. If the death benefit for a policy with more than one segment exceeds the $2,000,000 cap. the $2,000,000 will be allocated first to the original segment, and then to each subsequent segment until the $2,000,000 is reached.

If a policy face decreases below the GS IB minimum ($100,000), the rider will continue, applying the rates for the $100,000 band. If, however, the policy face decreases below $25,000, the rider will terminate.

When there is a partial surrender of face, the premium reduction will need to be processed in the same manner as for the base policy (e.g. LIFO, by segment).

GSIB premium and benefits do not vary by death benefit option. In the case of a death benefit option change, the premium charged per thousand of death benefit follow the rules of the base policy (e.g. if the base policy takes a change in band into account, so will the rider).

Convertibility:

If this rider is attached to a convertible term policy that is converted to a permanent policy, the rider will be allowed to be issued on the new permanent policy without underwriting assuming the rider is available on the new policy for the age and amount being issued.

Assignability:

Once an enhanced payout option is elected the payment stream may not be assigned to any other individual or entity. Payments will end upon the death of the beneficiary unless a period certain option is chosen. In that case the current payment will continue, without change, to the named recipient for the balance of the stated period.

Benefit Administration:

We will need to be able to transfer data and funds to the Annuity Administration area when the rider is exercised, similar to the process where data for LTC GPO riders is transferred to the Long-Term Care area when an insured elects to purchase the LTC policy under the provisions of his or her LTC-GPO rider.

The death proceeds will be deposited into the Total Control Account or some other interest bearing account while the beneficiary is deciding whether to elect an enhanced settlement payout under this rider.

Illustrations for GSIB:

New business illustration support for the GSIB is required. UI inputs and report output formats will support sales and marketing concepts with appropriate disclosures.

1. A computer system for providing a life insurance policy with an enhanced option rider, comprising:
an electronic database operable to store data related to policyholders and policy terms; and
an insurance administration computer, in communication with said database, for administering said policy;
wherein said enhanced option rider allows each beneficiary of said life insurance policy to apply all or part of eligible proceeds to one or more enhanced payment options, and wherein said one or more enhanced payment options comprise a guaranteed monthly payment through an annuitization process for the life of said one or more beneficiaries.

2. The system of claim 1, wherein the enhanced option rider further comprises a maximum allowable death benefit, and
wherein the eligible proceeds up to the maximum allowable death benefit are applied to said one or more enhanced payment options.

3. The system of claim 1, wherein the guaranteed monthly payment is guaranteed for a predetermined period of time.

4. The system of claim 3, wherein the one or more enhanced payment options comprise an escalation feature such that the guaranteed monthly payment increases during the life of said beneficiary.

5. The system of claim 1, wherein the enhanced option rider comprises provisions stating that the enhanced option rider cannot be added after the issuance of the life insurance policy and is not available for group conversions or guaranteed issue.

6. The system of claim 1, wherein the cost of the enhanced option rider may be calculated based on one or more of the following:
a. the death benefit of the life insurance policy on the policy date;
b. the death benefit of each requested increase in the face amount of the life insurance policy;
c. the death benefit of any riders on the life of the insured attached to the life insurance policy on the issue date of the policy; and
d. the death benefit of any rider on the life of the insured attached after the issue date of the life insurance policy.

7. The system of claim 6, wherein the cost of enhanced option rider does not include any death benefit paid under an accidental death benefit rider or other comparable riders.

8. The system of claim 1, wherein the enhanced option rider is terminated and the charges cease on the monthly anniversary following the receipt of written request to terminate the rider by the policy owner; or the life insurance policy being continued under a non-forfeiture option;
or the face of the life insurance policy decreasing below certain predetermined dollar amount.

9. The system of claim 1, wherein the enhanced option rider provides each beneficiary with a higher monthly death payment than the life insurance policy without the enhanced option rider.

10. The system of claim 1, further comprising an annuity administration module for processing the eligible proceeds in accordance with provisions of the enhanced option rider.

11. A method of administering an enhanced option rider for a life insurance policy, said life insurance policy providing eligible proceeds to one or more beneficiaries upon the death of the policy owner, said enhanced option rider allowing each beneficiary of the life insurance policy to apply all or part of eligible proceeds to one or more enhanced payment options, said one or more enhanced payment options comprising a guaranteed monthly payment through an annuitization process for the life of said beneficiary, the method comprising the steps of:
receiving an application for an enhanced option rider;
generating an enhanced option rider; and
if the enhanced option rider is exercised, then processing the proceeds of the life insurance policy according to the enhanced option rider; or
if the enhanced option rider has not been exercised, then holding the proceeds in an account until the enhanced option rider is exercised.
